(19) United States
(12) Patent Application Publication
(10) Pub. No.: US 2004/0112301 A1
(43) Pub. Date: Jun. 17, 2004

(54) Slider amusement for pets

(76) Inventors: Donald E. Freeman, Rocky Hill, CT (US); Susan T. Lennon, Rocky Hill, CT (US)

Correspondence Address: ALIX YALE & RISTAS LLP, 750 MAIN STREET, SUITE 1400, HARTFORD, CT, 06103, US

(21) Appl. No.: 10/320,151

(22) Filed: Dec. 16, 2002

(51) Int. Cl. A01K 29/00

(52) U.S. Cl. 119/707

(57) ABSTRACT

The present invention is directed to a slider device on which a dog or similar pet can place the front paws. As the device begins to slide on a sloped surface or the like, the pet, especially under the inducement of seeking a treat carried by the device, spontaneously begins pumping the hind legs to keep up with the sliding action. This provides the pet with exercise, entertainment, and enjoyment, and is quite amusing to watch. In one aspect of the invention, the slide amusement comprises a rigid, imperforate base having a smooth underside, a rough top side on which the pet places the front paws, a front end, a back end, an arcuate perimeter, such as semicircular, extending from the front end to the back end, and a raised rim substantially surrounding the base. A cavity or similar receptacle is preferable formed at the front end, for holding a treat for the pet.

### BACKGROUND OF THE INVENTION

The present invention relates to amusements for pets, in particular, to an amusement by which a canine pet can slide on a sloped or slippery surface of snow, sand, grass, or the like.

### SUMMARY OF THE INVENTION

The present invention is directed to a slider device on which a dog or similar pet can place the front paws. As the device begins to slide on a sloped surface or the like, the pet, especially under the inducement of seeking a treat carried by the device, spontaneously begins pumping the hind legs to keep up with the sliding action. This provides the pet with exercise, entertainment, and enjoyment, and is quite amusing to watch.

In one aspect of the invention, the slide amusement comprises a rigid, imperforate base having a smooth underside, a rough top side on which the pet places the front paws, a substantially straight back end, a front end, an arcuate perimeter, such as semicircular, extending from the front end to the back end, and a raised rim substantially surrounding the base. A cavity or similar receptacle is preferable formed at the front end, for holding a treat for the pet.

In another aspect, the invention is directed to a slide amusement having a rigid, imperforate base with a smooth, preferably polished, under side, a rough or other essentially non-slip top side, a substantially straight front or back end, and an opposite end, wherein the length of the straight end is in the range of about 16-32 inches and the distance from the one end to the other end is in the range of about 8 to 16 inches. A raised rim surrounds the base, at least along the front end and adjacent sides. A cavity at the front end preferably has a lid or cover which cannot easily be removed by the pet, thereby inducing the pet to take vigorous action on the slider with the objective of uncovering the treat. Of course, upon completion of the sliding session, the pet owner can remove the cover if the pet encounters difficulty.

### BRIEF DESCRIPTION OF THE DRAWINGS

A number of variations and enhancements to the inventive concept will be described below with respect to the accompanying drawings, in which:

FIG. 1 is a perspective view of one embodiment of the slider, having a semicircular shape and flat base;

FIG. 2 is a sectional view of a portion of the slider, along section line 2-2 of FIG. 1;

FIG. 3 is an illustration of the relationship of a canine pet to a variation of the slider device in use wherein the front portion of the base is curved upward;

FIG. 4 is a plan view of a “D” shaped variation of the slider;

FIG. 5 is a plan view of a different, “Delta” variation of the slider; and

FIG. 6 is a side view of another variation whereby the entire base is substantially curved.

### DESCRIPTION OF THE PREFERRED EMBODIMENT

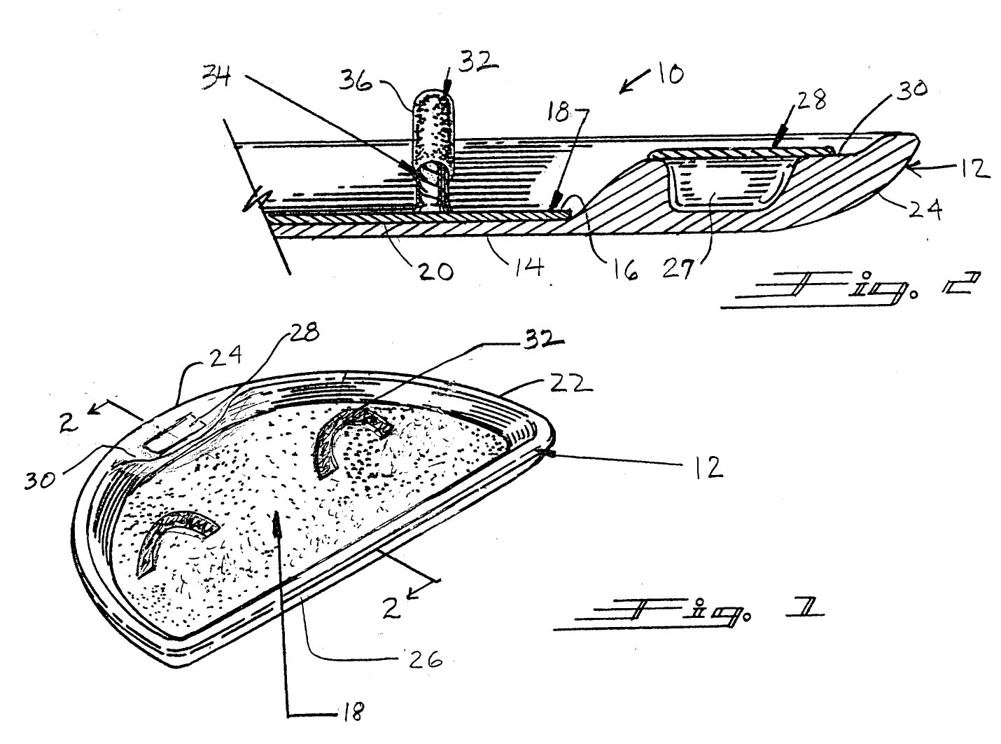

FIGS. 1 and 2 show a slider 10 according to one embodiment of the invention, having a substantially semicircular base 12 with a substantially flat, smooth, underside 14 and a non-slip surface 16 applied or attached as a covering 18 to the top side 20 of the base. A raised rim 22 surrounds the base and projects from the base a distance of preferably about ½ inch, up to about 1.5 inches, depending on the size of the slider (which should be commensurate with the size of the pet). For example, a small size slider would have a dimension along the straight back end 26, of about 16 inches, and a dimension from the front end 24 to the center of the back end 26, of about 8 inches; a medium size slider would have a back end length of about 24 inches and a front to back distance of about 12 inches; and a large size slider would have a back end length dimension of about 32 inches, and a front to back dimension of about 16 inches.

At or near the front end 24 of the device, a receptacle or holder, preferably in the form of cavity 27, is provided to receive an edible or other treat for the pet. Preferably, a removable cover 28 is provided whereby the treat is not readily accessible to the pet as the pet steps onto the slider and the slider moves, as illustrated in FIG. 3. At the end of the sliding event, when the slider and pet are stationary, the cover may be accessible to the pet for removal and enjoyment of the treat. In any event, the pet owner can then open the cover to reveal the treat. In the embodiment illustrated in FIGS. 1 and 2, the rim 22 is enlarged 30 at the center of the front end 24 whereby the cavity can be integrally formed therein.

In a further preference, the base 12 is made of heavy duty, high density plastic and the raised outer edge defining the rim 22, is more flexible and is covered with or consists of sturdy, flexible nylon or similar plastic. The bottom sliding surface 14 is polished to a high gloss for easy sliding and the top surface 16 has a comfortable non-slip texture. Optionally, but not as a requirement, on either side of the cavity 26 and slightly toward the back, two close-set strong handles 32, such as a rope 34 covered with nylon 36 or solid plastic or the like, are provided.

As shown in FIG. 3, the slider is designed to entice a dog to put the front paws on the non-slip surface and sniff for the treats. When the dog does so, the slider glides across the snow, sand or grass. The handle, non-slip surface and elevated rim gently inhibit the front paws from sliding out of the front of the device, while simultaneously providing the freedom to step off at any time. The pet's hind legs spontaneously begin pumping to keep up with the sliding action. The slider will glide when stepped onto from any edge, but the pet can eventually learn to step in from the back to provide maximum sliding capability. The more flexible rim and/or handles enable the dog to pick up the slider, either to shake the cover off for the treats to fall out or merely to run about carrying its “trophy”.

The base 12 in the embodiment of FIGS. 1 and 2 is flat on both the underside 14 and the top side 20 but, as shown for the slider 38 in FIG. 3, it is preferred that at least the portion of the underside of the base have a convex shape. In particular, the radius of curvature of the convex portion 14A should be smaller adjacent the front end 24, than the portion 14B adjacent the back end 26. In the embodiment of FIG. 3, the approximate back half 14B of the base is substantially straight, whereas the approximate front half 14A has the convex curvature.

FIG. 4 shows an alternative embodiment 40, wherein the base is substantially “D” shaped and the rim 42 is provided along only about ¾ of the perimeter, i.e., at the straight front end and adjacent sides. In the embodiment of FIG. 4, no treat receptacle or cavity is provided, nor any handles. Nevertheless, if sized appropriately, and if the pet undergoes a brief training, the embodiment of FIG. 4 can provide ample enjoyment for both the pet and the owner.

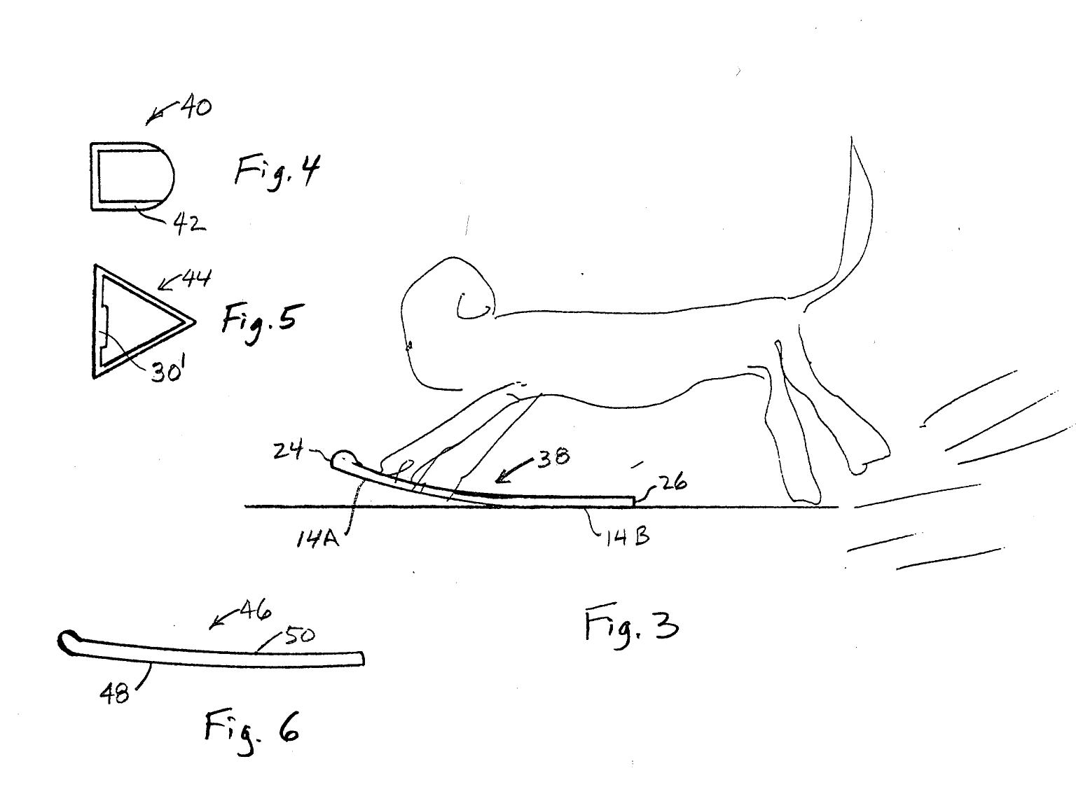

FIG. 5 illustrates yet another embodiment 44, wherein the base has a triangle or “delta” shape, with a treat receptacle centered in an enlargement 30′ at the front end.

FIG. 6 is an elevation view of yet another embodiment 46 which is similar to but with subtle differences relative to the embodiment of FIG. 3. In the embodiment of FIG. 6, the entire under side 48 of the base has a convex curvature, and the top side of the base and rim 50 have a similar curvature.

One of ordinary skill in designing and manufacturing amusement devices could readily determine through trial and error, those combinations of the shape of the base as viewed from above (as in FIGS. 1, 4, and 5), and the extent of curvature for both the underside and top side of the base, such that for small, medium and large pets, a respective small, medium and large size device will provide satisfactory performance for the purposes set forth herein.

1. A slide amusement for a pet, comprising:
a rigid, imperforate base having a smooth underside, a rough top side, a front end, a substantially straight back end, and an arcuate perimeter extending from the front end to back end;
a raised rim substantially surrounding the base; and
means at the front end for holding a treat for the pet.

2. The slide amusement of claim 1, wherein at least a portion of the underside of the base is convex.

3. The slide amusement of claim 2, wherein the radius of curvature of the convex portion is smaller adjacent the front end than adjacent the back end.

4. The slide amusement of claim 1, wherein the base is substantially flat adjacent the back end and the base is curved upwardly adjacent the front end.

5. The slide amusement of claim 1, wherein said rough top side of the base is a non-slip surface attached to the base.

6. The slide amusement of claim 1, wherein the base is substantially semi-circular.

7. The slide amusement of claim 1, including at least one handle means projecting from the base.

8. The slide amusement of claim 1, wherein the length of the straight back end is in the range of about 16 to 32 inches.

9. The slide amusement of claim 1, wherein the distance from the front end to the back end is in the range of about 8 to about 16 inches.

10. The slide amusement of claim 1, wherein the means for holding a treat is a cavity formed in the rim at the front end.

11. A slide amusement for a pet, comprising:
a rigid, imperforate base having a smooth underside, a rough top side, a substantially straight first end, and an opposite second end, wherein the length of the straight end is in the range of about 16 to 32 inches and the distance from the first end to the second end is in the range of about 8 to about 16 inches;
a raised rim surrounding the base at least along one end and the adjacent sides; and
means at said one end for holding a treat for the pet.

12. The slide amusement of claim 11, wherein the means for holding a treat is a cavity with a cover that can be opened and closed.

13. The slide amusement of claim 11, wherein the cavity is formed in the center of the rim.

14. The slide amusement of claim 13, wherein the cavity is formed in an enlargement of the rim at the second end.

15. The slide amusement of claim 11, wherein the rim is flexible and is raised above the base, a distance in the range of about 0.5 to about 1.5 inches.

16. The slide amusement of claim 11, wherein the base is substantially semi-circular.

17. The slide amusement of claim 11, wherein the base is substantially D-shaped.

18. A slide amusement for a pet, comprising:
an imperforate base having a smooth, at least partially convex underside, a top side having a non-slip surface, a substantially straight first end, an opposite second end, and an arcuate perimeter extending between the first end and the second end;
a raised rim substantially surrounding the base;
wherein the length of the straight first end is in the range of about 16 to 32 inches and the distance from the first end to the second end is in the range of about 8 to about 16 inches; and
the rim is raised above the base, a distance in the range of about 0.5 to about 1.5 inches.

19. The slide amusement of claim 18, including a cavity formed in the rim at one end for holding a treat for the pet and a cavity cover that can be opened and closed.

20. The slide amusement of claim 18, wherein the base is substantially flat adjacent one end and the base is curved upwardly adjacent the other end.
